(19) United States
(12) Patent Application Publication
(10) Pub. No.: US 2002/0112172 A1
(43) Pub. Date: Aug. 15, 2002

(54) System and method for secure distribution of digital products

(76) Inventor: Douglas Manning Simmons, Taipei (TW)

Correspondence Address: ST. ONGE STEWARD JOHNSTON & REENS, LLC, 986 BEDFORD STREET, STAMFORD, CT, 06905-5619, US

(21) Appl. No.: 10/040,821

(22) Filed: Jan. 7, 2002

Related U.S. Application Data
(63) Continuation of application No. PCT/GB00/02622, filed on Jul. 7, 2000.

(30) Foreign Application Priority Data
Jul. 9, 1999 (GB) 9916212.5

(51) Int. Cl. H04L 9/32

(52) U.S. Cl. 713/193; 380/201

(57) ABSTRACT

Books which are to be read on portable electronic reading devices (3) are distributed to readers on pre-recorded mini-discs (2). Each book is distributed in encrypted machine readable form and has a unique identification code (28) and each reading device has a unique serial code (19). When a mini-disc is inserted into a reading device and a reader chooses a book title, the reading device transmits its serial code and the identification code of the encrypted book to a control computer (4). The control computer processes the codes to generate a decryption key (34) from the serial code and the identification code and transmits the decryption key to the reading device which is thereby enabled to decrypt the encrypted book and display the pages of the book in human readable form.

This application is a continuation of pending International Application No. PCT/GB00/02622, filed on Jul. 7, 2000, which designates the United States and claims priority from British Application No. 9916212.5 filed on Jul. 9, 1999.

### FIELD OF THE INVENTION

The present invention relates to a system and method for electronically distributing reading material, such as books, periodicals and other publications and information, to potential readers. More especially, although not exclusively, it is concerned with authenticating the reading of encrypted reading material so as to assure payment to the supplier of the material.

There are many drawbacks to the conventional publishing of reading material, such as books, newspapers and magazines. For example, the publications require paper causing many trees to be cut down. A large amount of storage space is needed to store the publications. Also, the publications are distributed by transport means, such as lorries, causing pollution as a result. On the other hand, the publication of reading material electronically in a digital format, which publications may be referred to as electronic publications, alleviates these drawbacks and provides significant cost savings to the publisher. Also, the publications, being in an electronic format and being blocks or groups of digital data, can be conveniently manipulated by microprocessors. Such manipulation allows fonts or the size of text to be changed, for example.

There is, however, a problem in that electronic publications in digital format can be easily copied without the permission of the publisher.

### BACKGROUND OF THE INVENTION

WO 97/22099 describes an electronic publishing system. A user has an electronic reading device for reading publications where the reading device has its own dedicated or unique identification code or serial number. The user selects the type of access he requires for a publication that he wishes to purchase, such as only being able to read the publication on a particular reading device. A book card (a removable machine readable storage medium) containing the required publication is then encrypted at a retail establishment using the serial number of the reading device. The book card is then inserted into the reading device and the reading device can only decrypt the publication if the serial number used in the encryption matches the serial number of the reading device.

A problem with this system is that it does not allow numerous identical copies of publications to be electronically issued and distributed in an economical way, as individual encrypted publications are issued to individual purchasers at a retail establishment. This requires a retail margin to be paid and there are distribution costs in sending the book cards to retail establishments. The user of the reading device also has to make a trip to a retail establishment to get a publication. It is also relatively easy to decrypt the encrypted publication by simply discovering the serial number and using it to decrypt any publication.

WO 98/08344 describes an electronic publishing system in which an electronic reading device, having a serial number, is connected to a control computer when a user wants to obtain a publication. The control computer verifies the serial number of the reading device and the user of the electronic reading device selects the publication that he requires. The control computer encrypts the publication by using a private key corresponding to the serial number of the reading device and the encrypted publication is downloaded onto the reading device. The reading device then decrypts the publication by using the private key of the reading device.

This system also does not allow numerous identical copies of publications to be issued and electronically distributed, as individual encrypted publications are issued to individual reading devices. The system requires long on-line time as lengthy data files of required publications are downloaded and incurs associated on-line charges. The reading devices require expensive modems and large memories to store the requested publications. Also, the user is not given the chance of finding out much information about a publication before obtaining it and, any information received, is received while being on-line.

It is an object of the present invention to provide a system and method for electronically distributing publications which alleviates the above mentioned problems and allows a publisher to produce numerous identical copies for distribution with a high level of security. It is another object to provide a system and method for authenticating the purchase or procurement, by a reader, of electronic reading material stored in the memory of an electronic reading device or stored on a record medium which may be played back by the electronic reading device.

From one aspect, therefore, the invention consists in a system for electronically distributing reading material, comprising at least one electronic reading device having a dedicated serial code, and storing means for storing at least one block of digital data representing reading material in encrypted machine readable form and adapted to be accessed by the reading device, the block of data having an identification code, characterized by remote processing means having receiving means for receiving a serial code and an identification code transmitted thereto by the or a reading device, decryption key generating means for generating a decryption key in response to receipt of the serial code and the identification code, and transmitting means for transmitting a generated decryption key to the reading device, the reading device including decryption means for processing the decryption key and permitting decryption of the encrypted block of data, and display means for displaying at least part of the decrypted data.

From another aspect, the invention consists in a system for authenticating the procurement, by a reader, of electronic reading material stored in the form of at least one block of encrypted digital data in an electronic reading device having means for selecting a block of data representing required reading material, the reading device having a dedicated serial code and the or each block of data being associated with an individual identification code, characterized by remote processing means having decryption key generating means for receiving the serial code and the identification code of a selected block of data transmitted thereto from the reading device and for producing a decryption key in response to receipt thereof, and transmitting means for transmitting the generated decryption key to the reading device to permit decryption of the encrypted data.

The remote processing means may include means for storing an encryption data code, used to encrypt the block of digital data, in association with the identification code of the block of digital data encrypted with encryption data code. The reading device may have a concealed reading device code corresponding to its serial code and the remote processing means may also, or alternatively, store this concealed reading device code and the corresponding serial code. Hence, the decryption key generating means may be adapted to generate the decryption key based on the concealed reading device code identified by the serial code transmitted to the remote processing means and/or based on the encryption data code identified by the identification code. The concealed reading device code, the encryption data code and the relevant identification code are all preferably stored in a secure memory area at the remote processing means.

Conveniently, the decryption means of the reader device uses both the decryption key and the concealed reading device code to decrypt the block of encrypted data.

In a preferred embodiment, arrangements are provided for effecting payment for the generation and transmission of the decryption key.

The storing means may comprise a record disc, tape or other record medium on which the reading material is recorded separately from the reading device. The reading device may form part of a wired communication system and/or a wireless communication system.

From yet another aspect, the invention consists in method of electronically distributing reading material to readers provided with electronic reading devices having dedicated serial codes, characterized by the steps of producing blocks of digital data representing reading material in encrypted machine readable form, each block of data having a dedicated identification code; storing the blocks and identification codes at a reading device; actuating the reading device to select the block of data representing the required reading material; transmitting the serial code of the reading device and the identification code of the selected block of data to a remote processing station; processing the codes at the remote station to generate a decryption key transmitting the decryption key to the reading device; processing the encrypted block of digital data in conjunction with the decryption key to permit decryption of the data; and displaying at least part of the decrypted block of digital data.

### SUMMARY OF THE INVENTION

From a further aspect, the invention consists in a method of authenticating the procurement by a reader of reading material stored in the form of a block of encrypted digital data in an electronic reading device having a dedicated serial code, characterized by the steps of providing the blocks of digital data with dedicated identification codes, selecting with the reading device the block of data representing the required reading material, transmitting the serial code of the reading device and the identification code of the selected block of data to a remote processing station; processing the codes at the remote station to generate a decryption key, and transmitting the decryption key to the reading device.

### BRIEF DESCRIPTION OF THE DRAWINGS

An embodiment of the invention will now be described, by way of example only, with reference to the accompanying drawings, in which:

FIG. 1 is a schematic diagram of one embodiment of the invention;

FIG. 2 is a block diagram of an electronic reading device for use with the distribution system illustrated in FIG. 1;

FIG. 3 is a diagram showing the encoding process used by the distribution system; and

FIGS. 4 and 5 are diagrams showing the purchasing and decryption process.

### DETAILED DESCRIPTION OF THE DRAWINGS

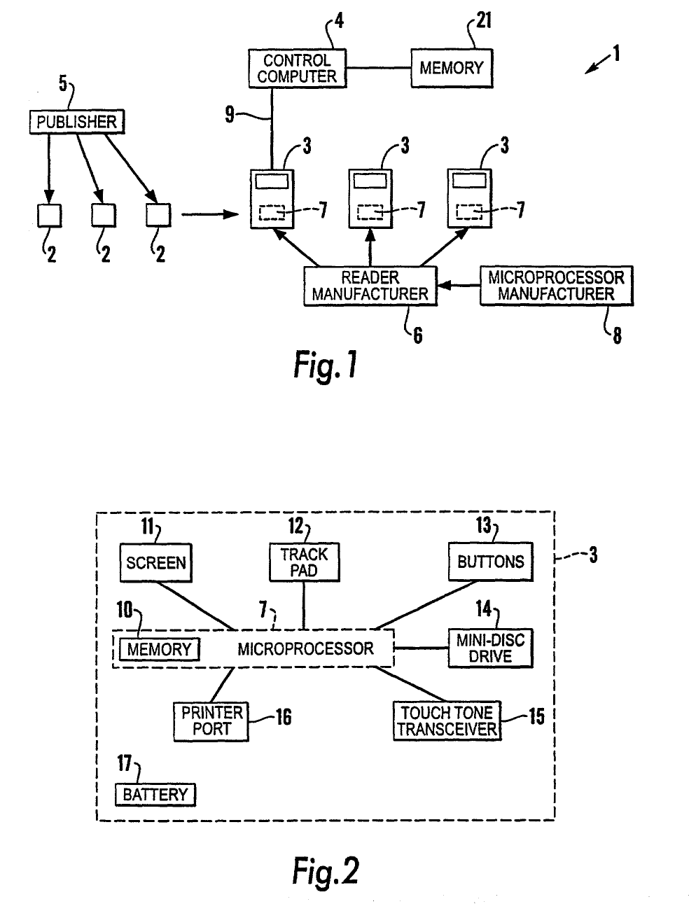

Referring to FIG. 1 of the accompanying drawings, the distributing system 1 comprises mini-discs 2 containing encrypted books or other publications, portable electronic reading devices 3 for reading the mini-discs, and a control computer 4 which is located at a remote processing station and which generates decryption keys for the encrypted publications. Each publication is identified by a unique identification code, such as an international standard book number (ISBN) or an international standard serial number (ISSN). Each identification code has a particular encryption key which is used to encrypt the corresponding publication. The encrypted publications are recorded on the mini-discs by a publisher 5 and the encrypted information relating to a particular publication is the same on every disc on which the encrypted publication is recorded on. The electronic reading devices 3 are manufactured by a reading device manufacturer 6 and a microprocessor 7, manufactured by a microprocessor manufacturer 8, is installed by the reading device manufacturer in each reading device. The reading device 3 can communicate with the control computer 4 via the public switched telephone network (PSTN) 9 and/or another communication system to which the control computer is connected, by means of which the reading device receives from the control computer the decryption key to decrypt a particular publication.

Referring to FIG. 2, the microprocessor 7 of the electronic reading device 3 includes a non-volatile memory 10. Connected to the microprocessor are a flat liquid crystal display (LCD) screen 11 for showing text and pictures, a track pad 12 for moving a cursor around the screen, buttons 13 for allowing a user to input information to the microprocessor, a mini-disc drive 14 for reading a mini-disc inserted into the reading device via a suitable slot (not shown), a dual tone multiplexed frequency (DTMF) touch tone transceiver 15 which is adapted to connect the reading device 3 to the PSTN, and a printer port 16 for enabling information viewed and/or stored on the reading device to be printed. The reading device 3 is powered by an internal rechargeable battery 17 which is recharged by a charger (not shown).

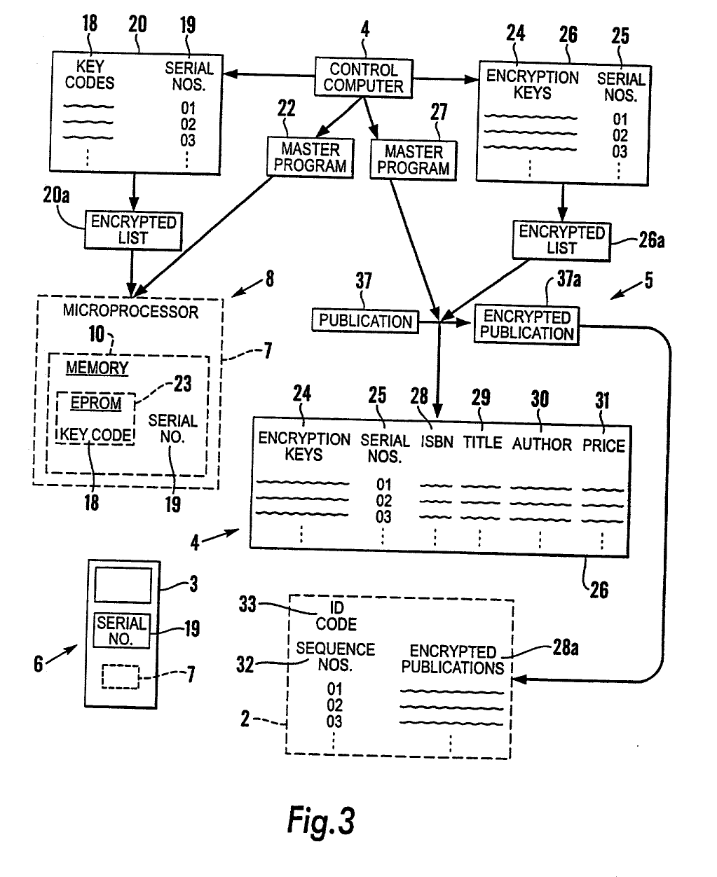

Referring to FIG. 3, the control computer 4 generates a list of unique key codes 18 and randomly allocates to each code a mathematically unrelated serial number or code 19. The list 20 of key codes 18 and serial numbers 19 are stored in a secure memory 21 (see FIG. 1) which can only be accessed by the control computer 4. The list of codes and serial numbers are encrypted and then sold to the microprocessor manufacturer 8. The manufacturer is provided with a master program 22 supplied by the control computer, which decrypts the encrypted list 20a of key codes and serial numbers and writes them into dedicated areas on the microprocessor 7. The key code 18 is written into an area 23 of memory 10, such as an erasable programmable read only memory (EPROM), which can only be read by the microprocessor. The serial number 19 is written into an area of memory 10 which can be read from outside the microprocessor.

The microprocessor manufacturer 8 prints the serial number 19 onto each completed microprocessor 7. A test is carried out to check that the serial number printed on the completed microprocessor matches the serial number stored in the memory of the microprocessor. After a batch of microprocessors has been completed, the microprocessor manufacturer purges and destroys all records of the key codes and serial numbers.

The completed batch of microprocessors 7, with their respective printed serial numbers 19, are supplied to the electronic reading device manufacturer 6 who copies the serial number onto a label which is adhered to the reading device which contains that particular microprocessor. The microprocessor also contains the concealed key code or reading device code 18 in a manner which prevents the code from being read from outside the microprocessor.

The control computer 4 also generates a list of unique encryption keys or data codes 24 and randomly allocates to each key a mathematically unrelated serial number 25, each encryption key corresponding to a particular publication. The list 26 of keys and serial numbers are stored in the secure memory 21. The list of keys and serial numbers are encrypted and the encrypted list 26a is then sold to the publisher 5.

The publisher 5 converts, into a required electronic form, the publications which are to be recorded on the mini-disc 2. The publisher is provided with a master program 27 supplied by the control computer 4, which encrypts, using the encryption keys 24, the parts of the publications 37 that he has pre-defined to be encrypted.

For each encrypted publication, the publisher 5 transmits to the control computer 4, for storage in the secure memory 21, an ISBN or an ISSN or any other unique identification code 28 to be associated with a respective serial number 25 allocated to the encryption key 24 used to encrypt that publication 37. Other information associated with the identification code 28, such as the title 29 of the publication, the author 30 and the price 31 in each country, is also transmitted to the control computer.

The publisher 5 publishes the encrypted electronic publication 37a on the mini-discs 2. Such mini-discs are available, for example, from the Sony Corporation and are small and cheap to manufacture. Many publications may be placed on one disc where the publications are listed by sequence numbers 32. Each mini-disc 2 is provided with an identification code 33 where the identification code is the same for identical copies of each disc. The discs are then distributed.

Much of the data on the mini-discs 2 is encrypted, but some parts, such as synopses, reviews and advertisements, are not. Potential buyers can view the decrypted parts and make a decision as to whether they will purchase access to any electronic publication on the mini-disc.

A user or reader obtains an electronic reading device 3 which he then programs with a personal identification number (PIN). Every time the reading device is switched on, the user needs to enter his PIN and have it verified before he can continue.

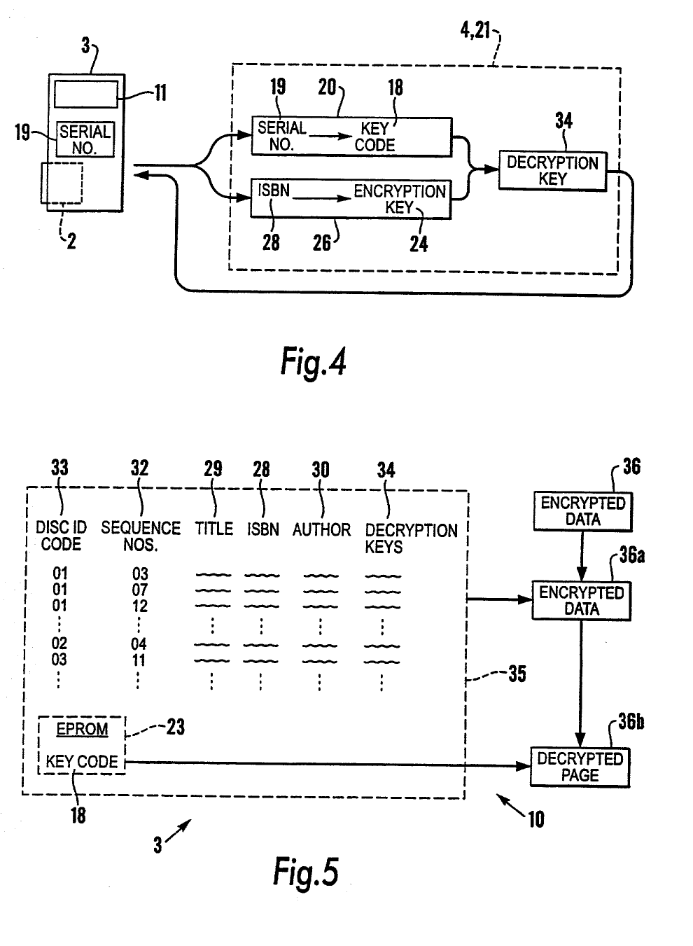

Referring to FIG. 4, a user obtains a mini-disc 2 and inserts the mini-disc into the mini-disc drive 14. The user can immediately view on the screen 11 the unencrypted data on the disc. To purchase an electronic publication, the user chooses a purchase option on a menu displayed on the screen, and enters his credit or bankcard number by clicking on numbers displayed on the screen with the track pad 12. Another menu option allows the user to enter his local access telephone number for the control computer 4. The user chooses an option to display the list of publications on the disc and highlights the title of the publication which he wishes to purchase. He then connects his reading device 3 to the PSTN 9 via the touchtone transceiver 15. The user selects a dial option and the reading device dials the local number for the control computer 4.

An electronic handshake is performed to confirm the connection between the electronic reading device 3 and the control computer 4. The reading device then automatically transmits the ISBN 28 of the publication being purchased, the reading device's serial number 19 and the user's credit or bankcard number.

The control computer 4 uses the ISBN 28 to find from the stored publication list 26, details about the book, such as the name of the author 30 and the price 31, and sends these details to the electronic reading device 3. The reading device requests the user to confirm his purchase.

After confirmation, the control computer 4 uses the reading device's serial number 19 to find from the reading device list 20 the reading device's secret or concealed key code 18, and finds from the publication list 26 the electronic publication's encryption key 24 from the ISBN 28. The control computer calculates a decryption key 34 using the reading device's secret key code 18 and the publication's encryption key 24 and the decryption key is transmitted to the reading device 3. The control computer debits the user's credit card or bank account by the amount for the publication and credits the publisher's account, less a commission for the owners of the control computer. The control computer 4 keeps a record of all publications purchased by each reading device 3. Upon receipt of the decryption key 34, the reading device indicates to the user that the purchase is completed and the user disconnects the reading device from the PSTN 9.

The control computer 4 produces receipts of purchases made and these are sent to the publisher.

Referring to FIG. 5, the electronic reading device 3 has a list 35 in its non-volatile memory 10 in which the decryption key 34 is stored. The decryption key is stored with the mini-disc identification code 33, the publication's sequence number 32 on the disc and the publication's title 29. Other details, such as the ISBN 28 and the author 30, may also be included.

To read a purchased publication, a user chooses a publication's title 29 from a list of purchased publications and mini-disc identification codes 33 displayed on the screen 11 and the mini-disc 2 with the appropriate code 33 is then inserted into the mini-disc drive 14. The microprocessor 7 looks up in the purchase list 35, the sequence number 32 of the required purchased publication and the encrypted first page 36 of that publication is downloaded into the memory 10 from the mini-disc 2. The reading device 3 references the decryption key 34 stored for that publication and uses it on the encrypted page. This generates a new set of data 36a which is still encrypted, but has a unique form. This is then decrypted by the reading device's key code 18 to produce a decrypted page 36b which can be read on the screen 11. Thus, the decryption key 34 will only decrypt pages of a particular encrypted publication 28a on a particular reading device 3. It will not decrypt other publications on that reading device, nor will it decrypt the chosen electronic publication on another reading device. The decryption key does not need to be secret as it is only when it is used with the reading device's concealed key code that an encrypted publication can be decrypted.

The user can chose a viewing style for that publication which is stored in the purchase list 35.

When an encrypted page 36 is downloaded into the memory 10, preceding encrypted pages (if any) and subsequent encrypted pages (if any) are downloaded into the memory 10 from the mini-disc 2 to form a continuous sequence of pages with, in general, the page to be viewed approximately in the middle of the sequence. When a page is read, the user presses a button 13 (see FIG. 2) to see the next page. The screen 11 displays animation of the page being turned like a book and the next page is displayed. Also, the page, following the last page in the sequence of pages in the memory 10, is downloaded from the inserted mini-disc 2. A similar process happens when another button 13 is pressed to turn back a page. The user also has the option of jumping to other pages of the publication. The memory 10 of the reading device is designed to hold only a few pages of the work being looked at, and as a new page is downloaded, it erases a previous page from the memory. When the publication is closed the pages in the memory are erased and the number of the last page viewed is stored in the purchase list 35 so that the next time the purchased publication is accessed, the last page viewed is initially displayed on the screen 11.

As previously mentioned, the control computer 4 keeps a record of all electronic publications sold to a portable electronic reading device 3. This record is kept indefinitely. Thus, if a reading device is replaced then the control computer can download to a replacement reading device revised decryption keys 34 making use of the replacement reading device's serial number. Also, if decryption keys are lost from the memory of a reading device they can be replaced.

Wherever reference to a function or operation occurs appropriate means for performing such a function or operation are considered as being referred to also.

An example of use of the distribution system 1, showing various benefits, is described below.

A publisher 5 has encrypted all the books by, say, a popular woman's author, who is about to release a new book. The publisher advises a top woman's magazine, and they decide to give away a free mini-disc 2 on the cover of the next issue of their magazine. The disc will include, say, sixty encrypted novels by this author, unencrypted selections from all of her published novels and the new, previously unpublished book, which is also encrypted.

A woman buys the magazine and finds attached to it a mini-disc 2 containing books by her favourite author. She inserts the disc into her reading device 3 and can immediately read the resumes and the first few unencrypted pages of each of the sixty novels. She tries the new novel and decides that she wants to buy it. She connects the reading device 3 to the PSTN 9 and purchases the book, which is decrypted by the decryption key 34 sent to her. Whenever she inserts this disc in the reading device, she can read this book and any others which she has purchased on that disc.

Thus, this system 1 is cheaper for the user as there are no retail margins and there are no distribution costs as the mini-discs 2 are distributed by the magazine. All it has cost the publisher 5 to produce this book is whatever it costs him to get to the point where he has the entire book in its finished electronic format. It is also more convenient for the user of the reading device 3 as the user does not need to leave her home and can buy the book for the cost of a minimum charge local phone call in addition to the purchase price.

Whilst a particular embodiment has been described, it will be understood that various modifications may be made without departing from the scope of the invention. For example, the memory 10 of the electronic reading device 3 may be designed to store decrypted works as opposed to inserting a disc each time book is required to be read.

The control computer 4 may not necessarily be a single computer but may comprise a network of computers and the secure memory 21 may comprises several secure memories.

The electronic publications may be distributed in any suitable way, such as on magnetic tape or on various types of read only memory (ROM), for example digitally versatile disc (DVD) ROM, compact disc (CD) ROM, EPROM and Flash ROM. The electronic reading device 3 will accordingly have a suitable reading mechanism to receive the distributed electronic material. The publications may also be distributed via the Internet or other suitable communication systems and the electronic reading device might be connected to the Internet or other suitable systems by an internal modem or any other suitable means. The reading device may be connected to a communication system by an external modem.

The electronic reading device 3 may be powered by non-rechargeable batteries or it may be connected to a mains supply. The printer port 16 is optional. A flash card socket may be provided in the reading device so that the memory of the reading device can be increased. The user may also have the option of deleting information stored on the reading device.

The track pad 12 on the electronic reading device 3 may be replaced by any suitable device for moving a cursor around the screen 11, such as an internal mouse or a track ball. Any suitable means may be used to choose menus/options or turn pages of an electronic publication. The pages of the publication may be scrolled as opposed to being turned.

The system may be designed so that electronic reading devices 3 can display the text in any particular language, such as Chinese or Arabic. For newspapers and magazines which have larger formats than books, each page may only display headlines and small sized pictures. The user can click on a headline so that the story associated with the headline is displayed, and the user can also click on the picture so that it can be enlarged on the display. A screen back light may be provided to brighten displayed information in poor light.

The reading device 3 may store a user's credit card number instead of requiring it to be entered each time a purchase is required. If a user does not have a credit or bankcard or does not want to use it then the user can take his reading device to a retail establishment which has a device attached to the PSTN. The user then purchases his book in the usual manner except that the device sends the control computer 4 the shop's account number instead of the user's credit card number and the user pays the retail establishment instead for the purchase and also pays them a small service charge.

Use of PINs is optional. If a PIN is used, it may be transmitted to the control computer 4 as part of the purchasing process.

An encrypted publication may have an associated printer code which defines how much of the electronic publication may be printed.

As part of the encryption process of a book or other publication, the control computer 4 may issue a code for use as a partial key by the encryption publication software 27 making use of the ISBN 28 sent to the control computer by the publisher 5.

The portable electronic reading device 3 may include a radio receiver for receiving data from off-air networks, such as paper or mobile phone networks. This is used to update, say, a purchased newspaper from a mini-disc 2. For example, a newspaper publisher sends the latest information via an integrated services digital network (ISDN) link to a radio network where it fills gaps in the network's normal transmissions. If a user is reading a purchased newspaper on a mini-disc 2 inserted in the reading device 3, then the latest information relating to the newspaper is received by the receiver and what the user is reading is updated if necessary. Thus, the user can always get updated information and does not need to connect the reading device 3 to the PSTN 9.

What is claimed is:

1. A system (1) for electronically distributing reading material, comprising at least one electronic reading device (3) having a dedicated serial code (19), and storing means (2) for storing at least one block of digital data (37a) representing reading material in encrypted machine readable form and adapted to be accessed by the reading device, the block of data having a identification code (28), characterized by
remote processing means (4) having receiving means for receiving a serial code and an identification code transmitted thereto by the or a reading device, decryption key generating means for generating a decryption key (34) in response to receipt of the serial code and the identification code, and transmitting means for transmitting a generated decryption key to the reading device, the reading device including decryption means for processing the decryption key and permitting decryption of the encrypted block of data, and display means (11) for displaying at least part of the decrypted data (36b).

2. A system for authenticating the procurement, by a reader, of electronic reading material stored in the form of at least one block of encrypted digital data in an electronic reading device (3) having means for selecting a block of data representing required reading material, the reading device having a dedicated serial code (19) and the or each block of data being associated with an individual identification code (28), characterized by
remote processing means (4) having decryption key generating means for receiving the serial code and the identification code of a selected block of data transmitted thereto from the reading device (3), and for producing a decryption key (34) in response to receipt thereof, and transmitting means for transmitting the generated decryption key to the reading device to permit decryption of the encrypted data.

3. The system claimed in claim 1 or 2, wherein the remote processing means (4) includes means for storing an encryption data code (24), used to encrypt the block of digital data (37a), in association with the identification code of the block of digital data (37a) encrypted with encryption data code.

4. The system claimed in claim 1, 2 or 3, wherein the reading device (3) has a concealed reading device code (18) associated with its serial code (19), and the remote processing means (4) includes means for storing the concealed reading device code and its associated serial code (19) at the remote processing means.

5. The system claimed in claim 4, wherein the decryption key generating means is adapted to generate the decryption key (34) based on the concealed reading device code (18) identified by the serial code (19) transmitted to the remote processing means.

6. The system claimed in claim 4 or 5, wherein the decryption key generating means is adapted to generate the decryption key (34) based on the encryption data code (24) identified by the identification code (28).

7. The system claimed in claim 4, 5 or 6, wherein the remote processing means (4) stores the concealed reading device code (18), the encryption data code (24) and the relevant identification code (28) in a secure memory area (21).

8. The system claimed in any preceding claim 4 to 7, wherein the decryption means of the reading device (3) uses the decryption key (34) and the reading device code (18) to decrypt the block of encrypted data (37a).

9. The system claimed in claim 8, wherein the decryption means processes the block of encrypted digital data with the decryption key (34) to produce a new block of data (36a) in a uniquely encrypted format which is adapted to be decrypted by the concealed reading device code (18) in the reading device to produce human readable material for display on the display means (11) of the reading device (3).

10. The system claimed in any preceding claim, wherein the remote processing means (4) includes means responsive to initial receipt of the serial code and identification code for transmitting particulars of the selected reading material to the reading device (3) for confirmation purposes, and wherein the decryption key generating means generates the decryption key (34) in response to a confirmation signal transmitted from the reading device.

11. The system claimed in any preceding claim, including means for effecting payment for the generation and transmission of the decryption key (34) to enable the reading device (3) to display at least part of the decrypted data (36b).

12. The system claimed in any preceding claim, wherein the storing means (2) comprises a record disc, tape or other record medium on which the reading material is recorded separately from the reading device.

13. The system claimed in any preceding claim, wherein the or each reading device (3) forms part of a wired communication system and/or a wireless communication system.

14. The system claimed in any preceding claim, including means for entering a user identification code on the or each reading device (3) and verification means for verifying the user identification code.

15. The system claimed in any preceding claim, wherein the or each reading device (3) includes a receiver for receiving a second block of digital data via a wireless communication system.

16. The system claimed in claim 15, wherein the second block of digital data comprises information to update information contained in the first block of data (37a)

17. A method of electronically distributing reading material to readers provided with electronic reading devices (3) having dedicated serial codes (19), characterized by the steps of:
producing blocks of digital data (37a) representing reading material in encrypted machine readable form, each block of data having a dedicated identification code (28);
storing the blocks (37a) and identification codes at a reading device;
actuating the reading device to select the block of data representing the required reading material;
transmitting the serial code of the reading device and the identification code of the selected block of data to a remote processing station (4);
processing the codes at the remote station to generate a decryption key (34);
transmitting the decryption key to the reading device;
processing the encrypted block of digital data in conjunction with the decryption key to permit decryption of the data; and
displaying at least part of the decrypted block of digital data (36b).

18. A method of authenticating the procurement by a reader of reading material stored in the form of a block of encrypted digital data in an electronic reading device (3) having a dedicated serial code (19), characterized by the steps of
providing the blocks of digital data (37a) with dedicated identification codes (28),
selecting with the reading device the block of data representing the required reading material,
transmitting the serial code of the reading device and the identification code of the selected block of data to a remote processing station (4);
processing the codes at the remote station to generate a decryption key (34), and
transmitting the decryption key to the reading device.

19. The method claimed in claim 17 or 18, wherein an encryption data code (24) used for encrypting the digital data (37a) is stored at the remote processing station and the relevant encryption data code is identified in response to the transmission to the station of the identification code associated with the selected block of data.

20. The method claimed in claim 19, including storing in the or each reading device (3) and at the remote processing station (4), a concealed reading device code (18) corresponding to the serial code (19) of the or each reading device.

21. The method claimed in claim 20, wherein the relevant concealed reading device code (18) is identified at the remote processing station in response to the transmission thereto of the corresponding reading device serial code (19).

22. The method claimed in claim 20 or 21, wherein the decryption key (34) is generated based on the concealed reading device code (18) identified by the serial code (19) transmitted to the remote processing station.

23. The method claimed in claim 19, 20, 21 or 22, wherein the decryption key (34) is generated based on the encryption data code (24) identified by the identification code (28) transmitted to the remote processing station.

24. A method claimed in claim 20, 21, 22 or 23, wherein the block of data is decrypted at the reading device (3) using the decryption key (34) and the concealed reading device code (18).

25. A method claimed in claim 24, wherein the block of encrypted digital data is processed with the decryption key (34) to produce a new block of data (36a) in a uniquely encrypted format which is decrypted by the concealed reading device code (18) to produce human readable material for display.

26. The method claimed in any preceding claim 17 to 25, wherein initially upon transmission of a serial code (19) and the identification code (28) relating to the selected block of data, the remote processing station transmits particulars of the corresponding reading material to the reading device, and wherein the decryption key (34) is generated in response to a confirmation signal transmitted from the reading device.
